(19) United States
(12) Patent Application Publication
(10) Pub. No.: US 2023/0107268 A1
(43) Pub. Date: Apr. 6, 2023

(54) SHELF LIGHTING DEVICE

(71) Applicant: Corning Incorporated, Corning, NY (US)

(72) Inventors: Euisoo Kim, Seongnam-si (KR); Hong Yoon, Asan-si (KR)

(21) Appl. No.: 17/798,444

(22) PCT Filed: Feb. 4, 2021
(86) PCT No.: PCT/US2021/016533

§ 371 Date: Aug. 9, 2022

(30) Foreign Application Priority Data
Feb. 11, 2020 (KR) 10-2020-0016137

(51) Int. Cl. F21V 33/00; F21V 8/00

(52) U.S. Cl. CPC F21V 33/0012; G02B 6/0088; G02B 6/0043

(57) ABSTRACT

Provided is a shelf lighting device. A light guide plate is disposed below a shelf to which external contacts are made, includes a first surface facing the shelf, a second surface opposite the first surface, and third surfaces extending between edges of the first and second surfaces to connect the first and second surfaces, is formed from a first refractive index material, and guides light. An area in which light is guided is separated from an area in which external contacts are made, such that light is not extracted directly from a stained portion, thereby reducing sensitivity to surface contamination.

### CROSS-REFERENCE TO RELATED APPLICATIONS

This application claims the benefit of priority under 35 U.S.C. Of Korean Patent Application Serial No. 10-2020-0016137 filed on Feb. 11, 2020, the content of which is relied upon and incorporated herein by reference in its entirety.

### FIELD

The present disclosure relates to a shelf lighting device and, more particularly, to a shelf lighting device having a structure able to separate an area in which light is guided from an area in which external contacts are made, such that light is not extracted directly from a portion stained by fingerprints, food, or the like, thereby reducing the sensitivity thereof to surface contamination.

### DESCRIPTION OF RELATED ART

In general, a light guide plate is provided as a high transmittance substrate formed from acryl, polycarbonate, or the like, and serves to disperse light therethrough using total internal reflection (TIR) occurring when light travels from a higher-refractive medium to a lower-refractive medium. Light traveling through the interior of the light guide plate exits the light guide plate when meeting light extraction sites and is then refracted.

In addition, when such a light guide plate is used as a shelf, the entirety of the shelf may be used as a lighting means, thereby creating new value for shelves disposed in refrigerators, product display shelves disposed in shops, or the like. Here, since such a shelf is frequently touched by users, the shelf may be easily contaminated with fingerprints, liquid, or the like. In particular, the light guide plate is significantly vulnerable to contamination. When a fingerprint is left on a surface of the light guide plate, a portion stained by the fingerprint acts as a light extraction site. Thus, a faint trace, such as a fingerprint, not easily seen when light is not guided, i.e. when a light source is turned off, may brightly glow when light is guided. That is, the fingerprint may clearly appear. Such a problem may lead to a phenomenon that a light guide plate itself serving as a shelf may attract attention, rather than products placed thereon. Since most light guide plates have significant light guide effects, it may be substantially impossible to make fingerprints invisible. Accordingly, it may not easy to commercialize a shelf lighting device using the light guide plate.

### RELATED ART DOCUMENT

Patent Document 1: Korean Patent No. 10-1780426 (Sep. 14, 2017)

### SUMMARY

Various aspects of the present disclosure provide a shelf lighting device having a structure able to separate an area in which light is guided from an area in which external contacts are made, such that light is not extracted directly from a portion stained by fingerprints, food, or the like, thereby reducing the sensitivity thereof to surface contamination.

According to an aspect, a shelf lighting device includes: a shelf to which external contacts are made; a light guide plate disposed below the shelf, including a first surface facing the shelf, a second surface opposite the first surface, and third surfaces extending between edges of the first surface and the second surface to connect the first surface and the second surface, formed from a material having a first refractive index n₁, and configured to guide light; a first adhesive layer disposed between the shelf and the first surface of the light guide plate and formed from a material having a second refractive index n₂; and at least one light source disposed to face at least one third surface among the third surfaces and emitting light in a direction toward the light guide plate. Here, an angle θ of incidence of light to the light guide plate from the light source may satisfy the following formula:

$$θ \leq {sin}^{- 1} ( sin ( {cos}^{- 1} ( \frac{{n}_{2}}{{n}_{1}} ) ) ⨯ {n}_{1} )$$

In some embodiments, the shelf lighting device may further include: a cover disposed below the light guide plate and a second adhesive layer disposed between the cover and the second surface of the light guide plate, the second adhesive layer being formed from a material having a third refractive index n₃. Here,

the angle θ of incidence of light to the light guide plate from the light source may satisfy the following formula:

$$θ = \leq {sin}^{- 1} ( sin ( {cos}^{- 1} ( \frac{{n}_{4}}{{n}_{1}} ) ) ⨯ {n}_{1} )$$

where n₄=n₂ when n₂≥n₃, and n₄=n₃ when n₃≥n₂ (n₄=n₂≥n₃ or n₄=n₃≥n₂).

In some embodiments, the angle of incidence of light to the light guide plate from the light source may be 42.6 degrees or less.

In some embodiments, the second refractive index n₂ may be lower than the first refractive index n₁.

In some embodiments, the second refractive index n₂ may be 1.45 or lower.

In some embodiments, the light guide plate may be formed from glass.

In some embodiments, at least one of the first adhesive layer and the second adhesive layer may be formed from polymer.

In some embodiments, at least one of the first adhesive layer and the second adhesive layer may be one material selected from a candidate group including ultraviolet (UV) resin and a pressure sensitive adhesive (PSA).

In some embodiments, at least one of the first adhesive layer and the second adhesive layer may have a thickness ranging from 3 μm to 30 μm. In a case in which the at least one adhesive layer is formed from a liquid resin, the liquid resin may be applied to a thickness ranging from 3 μm to 30 μm. In a case in which the at least one adhesive layer is molded in the shape of a film, the thickness of the adhesive layer molded the shape of a film may range from 20 μm to 300 μm.

In addition, the light source may be a light-emitting diode (LED).

In addition, the shelf lighting device may further include a light-scattering pattern provided on at least one of the first surface and the second surface.

According to the present disclosure, substrates to which external contacts are made are provided over and below a substrate in which light is guided (i.e. the light guide plate), lower-refractive layers formed from a material having a lower refractive index than the material of the light guide plate are respectively disposed between the light guide plate and the substrates to which external contacts are made, and the angle of incidence of light to the light guide plate from the LEDs is limited. Thus, the area in which light is guided may be separated from the area to which external contacts are made, so that light may be prevented from being directly extracted from portions contaminated with fingerprints, food, or the like, thereby reducing the sensitivity of the shelf lighting device to surface contamination with fingerprints, food, or the like.

In addition, according to the present disclosure, both a lighting function and a function as a shelf may be provided to further highlight products placed on the shelf, thereby creating new added value.

The methods and apparatuses of the present disclosure have other features and advantages that will be apparent from or that are set forth in greater detail in the accompanying drawings, the disclosures of which are incorporated herein, and in the following Detailed Description, which together serve to explain certain principles of the present disclosure.

### DESCRIPTION OF THE DRAWINGS

FIG. 1 is a conceptual view schematically illustrating a shelf lighting device according to embodiments of the present disclosure.

### DETAILED DESCRIPTION

Hereinafter, a shelf lighting device according to embodiments of the present disclosure will be described in detail with reference to the accompanying drawings.

Throughout this document, reference should be made to the drawings, in which the same reference numerals and symbols will be used to designate the same or like components. In the following description, detailed descriptions of known functions and components incorporated into the present disclosure will be omitted in the case in which the subject matter of the present disclosure is rendered unclear by the inclusion thereof.

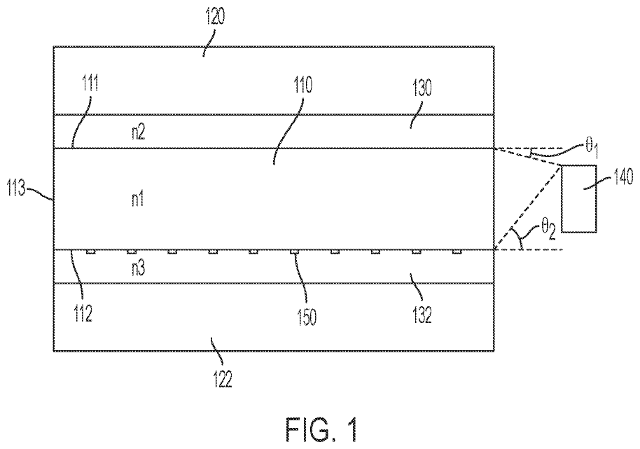

As illustrated in FIG. 1, a shelf lighting device 100 according to embodiments of the present disclosure is a functional lighting device able to provide both a function as a shelf (hereinafter, referred to as a “shelf function”) and a lighting function, thereby further highlighting products placed on the shelf by lighting. For example, the shelf lighting device 100 may be used as a shelf disposed within a refrigerator, a product display shelf in an exhibition hall, or the like.

The shelf lighting device 100 includes a light guide plate 110, a shelf 120, a cover 122, a first adhesive layer 130, a second adhesive layer 132, and a light source 140.

The light guide plate 110 serves to guide light. In embodiments of the present disclosure, an area in which light is guided is separated from an area to which external contacts are made. Thus, in embodiments of the present disclosure, the light guide plate 110 will be defined as an area in which light is guided.

The light guide plate 110 includes a first surface 111, a second surface 112 opposite the first surface 111, and third surfaces 113 extending between edges of the first surface 111 and the second surface 112 to connect the first surface 111 and the second surface 112.

In embodiments of the present disclosure, the first surface 111 is defined as the top surface of the light guide plate 110 (when viewed in the orientation depicted in the drawing) through which light generated by the light source 140 exits. In addition, in the same manner as the first surface 111, the second surface 112 is defined as the bottom surface of the light guide plate 110 (when viewed in the orientation depicted in the drawing) through which light generated by the light source 140 exits. Thus, the shelf lighting device 100 according to embodiments of the present disclosure emits light through both the first surface 111 and the second surface 112. In addition, since the shelf lighting device 100 according to embodiments of the present disclosure has an edge-lit structure, the third surfaces 113 are defined as side surfaces of the light guide plate 110 (when viewed in the orientation depicted in the drawing) facing the light source 140 implemented with light-emitting diodes (LEDs).

In embodiments of the present disclosure, the light guide plate 110 may be formed from a material having a first refractive index n₁. For example, the light guide plate 110 formed from glass, more particularly, toughened glass or strengthened glass. In embodiments of the present disclosure in which the light guide plate 110 is formed from glass, the refractive index n₁ of the light guide plate 110 may be 1.51. In some embodiments, the light guide plate may be a transparent substrate. Since the higher the elastic modulus the less flexible the plate is, a material having a higher modulus may be used for the light guide plate. For example, when a shelf is formed from plastic, downward sagging of the plastic shelf due to gravity is more severe than that of a glass shelf. Thus, glass may be more preferable than plastic for the light guide plate. Among a plurality of types of glass, IRIS™ Glass developed exclusively for the light guide plate may be desirable, and low-iron glass may also be used. Although general architectural glass may be used, it may not be preferred, due to the problem of green discoloration thereof. However, the present disclosure is not limited thereto, and a variety of materials may be used for the light guide plate.

In addition, a plurality of light spots to extract light guided within the light guide plate 110 are provided on the second surface 112 of the light guide plate 110, thereby forming a light-scattering pattern 150. The thickness of the light-scattering pattern 150 is not limited to a specific range. However, when the thickness of the light-scattering pattern 150 is increased, the thickness of the adhesive layer must be increased to be the same as or greater than the thickness of the light-scattering pattern 150. In some embodiments, the light-scattering pattern may be provided on the first surface 111. In some embodiments, the light-scattering pattern may be provided on the first surface 111 and the second surface 112.

In some embodiments, the light-scattering pattern may be formed from a light-scattering resin, such as a white resin, by a variety of methods, such as screen-printing, inkjet printing, or spray printing. In some embodiments, the light-scattering pattern may have a variety of shapes, such as a dot pattern, on the first surface 111 or the second surface 112. In some embodiments, each dot of the dot pattern may have a variety of cross-sections, such as a quadrangular cross-section. However, the present disclosure is not limited thereto, and a variety of other embodiments may be provided.

In some embodiments, the light-scattering pattern may be, for example, an engraved pattern formed by a variety of methods, such as a method of mechanically scraping the surface or a method of melting the surface using a laser. In some embodiments, the light-scattering pattern may have a variety of shapes, such as a stripe pattern, a mesh pattern, or a dot pattern, on the first surface 111 or the second surface 112. In some embodiments, respective units of the pattern may have a variety of cross-sections, such as a V-shaped cross-section, a quadrangular cross-section, or a semielliptical cross-section. However, the present disclosure is not limited thereto, and a variety of other embodiments may be provided.

In some embodiments, the light-scattering pattern may be provided by forming lenses by a variety of methods, such as inkjet printing or screen-printing. In some embodiments, the lenses may have a variety of shapes, such as a dot pattern, on the first surface 111 or the second surface 112. However, the present disclosure is not limited thereto, and a variety of other embodiments may be provided.

The shelf 120 is defined as the area separated from the light guide plate 110 defined as the area in which light is guided. That is, the shelf 120 is defined as the area to which external contacts are made. Thus, products are placed on the shelf 120, so that the shelf 120 may be easily contaminated with foreign matter, such as human fingerprints, food, or liquid.

The shelf 120 is disposed on the first surface 111 of the light guide plate 110. That is, the shelf 120 is disposed over the light guide plate 110 (when viewed in the orientation depicted in the drawing). In embodiments of the present disclosure, the shelf 120 may be formed from polyethylene terephthalate (PET), glass, or the like.

In some embodiments, the cover 122 is disposed on the second surface 112 of the light guide plate 110. That is, the cover 122 is disposed below the light guide plate 110 (when viewed in the orientation depicted in the drawing). In embodiments of the present disclosure, the cover 122 may be formed from PET, glass, or the like.

As described above, in embodiments of the present disclosure, the light guide plate defining the area in which light is guided and the shelf 120 defining the area to which external contacts are made are provided separately from each other. As a result, direct extraction of light from a contaminated portion of the shelf 120 stained by fingerprints, food, or the like may be prevented. Direct extraction of light may only be allowed through the light guide plate 110. Accordingly, the sensitivity of the shelf lighting device to surface contamination due to fingerprints, food, or the like may be reduced.

As described above, the shelf lighting device 100 according to embodiments of the present disclosure includes the first adhesive layer 130 and the second adhesive layer 132 in order to provide both the shelf function and the lighting function such that the area in which light is guided and the area to which external contacts are made are separated from each other.

The first adhesive layer 130 is disposed between the first surface 111 of the light guide plate 110 and the shelf 120 disposed over the light guide plate 110 (when viewed in the orientation depicted in the drawing) to bond the light guide plate 110 and the shelf 120. In addition, the second adhesive layer 132 is disposed between the second surface 112 of the light guide plate 110 and the cover 122 disposed below the light guide plate 110 (when viewed in the orientation depicted in the drawing) to bond the light guide plate 110 and the cover 122.

In embodiments of the present disclosure, the first adhesive layer 130 may be formed from a material having a second refractive index n₂. In addition, the second adhesive layer 132 may be formed from a material having a third refractive index n₃. Here, each of the second refractive index n₂ of the material, from which the first adhesive layer 130 is formed, and the third refractive index n₃ of the material, from which the second adhesive layer 132 is formed, is lower than the refractive index n₂ of the material, from which the light guide plate 110 is formed. That is, in embodiments of the present disclosure, each of the first adhesive layer 130 and the second adhesive layer 132 is provided as a lower refractive layer having a lower refractive index than the light guide plate 110. Here, the second refractive index n₂ of the material of the first adhesive layer 130 and the third refractive index n₃ of the material of the second adhesive layer 132 may respectively be 1.45 or lower.

In embodiments of the present disclosure, each of the first adhesive layer 130 and the second adhesive layer 132 may be formed from polymer. For example, each of the first adhesive layer 130 and the second adhesive layer 132 may be one selected from a candidate group of lower refractive materials including an ultraviolet (UV) resin and a pressure-sensitive adhesive (PSA). For example, when the first adhesive layer 130 and the second adhesive layer 132 are formed from the PSA, each of the refractive index n₂ of the first adhesive layer 130 and the third refractive index n₃ of the second adhesive layer 132 is lower than the refractive index n₂ of glass, from which the light guide plate 110 is formed. In some embodiments, the thickness of each of the first adhesive layer 130 and the second adhesive layer 132 may be 3 μm or more. Considering that the adhesive layer has a high unit price, an increase in the thickness may lead to an increase in costs. In embodiments of the present disclosure, the thickness of each of the first adhesive layer 130 and the second adhesive layer 132 may be 10 μm or less.

The shelf lighting device 100 with the first adhesive layer 130 and the second adhesive layer 132 formed from the lower refractive material having a lower refractive index than the light guide plate 110 may reduce the overall weight of the shelf lighting device 100 while further simplifying the fabrication of the shelf lighting device 100 in which the area in which light is guided and the area to which external contacts are made are separated.

Since the shelf lighting device 100 has the edge-lit structure, the light source 140 faces one of the third surfaces 113 defined as the side surfaces of the light guide plate 110. In embodiments of the present disclosure, the light source 140 may be implemented with LEDs.

Here, in order to provide both the shelf function and the lighting function such that the area in which light is guided and the area to which external contacts are made are separated from each other, embodiments of the present disclosure provide the first adhesive layer 130 and the second adhesive layer 132, each of which is formed from the lower-refractive material, and limit the angle of incidence of light emitted from the light source 140 and incident to the light guide plate 110 serving as the area in which light is guided.

That is, in embodiments of the present disclosure, angles of incidence θ1, θ2, and . . . of light to the light guide plate 110 from the light source 140 may be determined by Formula 1:

$$θ \leq {sin}^{- 1} ( sin ( {cos}^{- 1} ( \frac{{n}_{4}}{{n}_{1}} ) ) ⨯ {n}_{1} ) \qquad ( 1 )$$

In the Formula above, n₄ is equal to n₂ when n₂≥n₃ or n₄ is equal to n₃ when n₃≥n₂ (n₄=n₂≥n₃ or n₄=n₃≥n₂). That is, a greater of n₂ and n₃ is equal to n₄, and when n₂ and n₃ are equal, n₄=n₂=n₃.

In some embodiments, the light guide plate 110 is formed from glass, in which the refractive index n₁ of the light guide plate 110 may be 1.51. In addition, in some embodiments, each of the first adhesive layer 130 and the second adhesive layer 132 is formed from the PSA, in which the refractive index n₂ of each of the first adhesive layer 130 and the second adhesive layer 132 may be 1.35. In these embodiments, the angle of incidence θ of light to the light guide plate 110 from the light source 140 is limited to the formula: sin⁻¹(sin(cos⁻¹(1.35/1.51))×1.51)=42.6°.

As described above, embodiments of the present disclosure provide the first adhesive layer 130 having the lower refractive index than the material of the light guide plate 110 between the area in which light is guided and the area to which external contacts are made and limit the angle of incidence θ of light to the light guide plate 110 from the light source 140 in accordance with Formula 1. Since typical LED packages used for lighting extract a significant quantity of light at angles equal to or greater than 60°, an additional device limiting the maximum light-emitting angle may be used, or an LED package, the angle of incidence of which is limited to a narrower range, may be used.

Descriptions of specific structures and methods will be omitted, since details thereof are beyond the scope of the present disclosure. The shelf lighting device as described above can prevent direct extraction of light from the shelf 120 serving as a contamination area stained, or highly probable to be stained, with fingerprints, food, or the like, thereby reducing the sensitivity of the shelf lighting device to surface contamination with fingerprints, food, or the like. In a lighting device only including the light guide plate, when light strikes a contaminated portion on the surface of the light guide plate while traveling through the interior of the light guide plate, a large portion of the light that has struck the contaminated portion exits, thereby causing the contaminated portion to be clearly visible. In contrast, in the present disclosure, even in the case that light strikes a contaminated portion on the shelf 120 after having passed through the first adhesive layer 130, the quantity of the light striking the contaminated portion is small. Thus, fingerprints or the like may be prevented from being clearly visible.

In some embodiments, a shelf lighting device 100 may not include the cover 122 or the second adhesive layer 132. In particular, in a shelf lighting device having a structure preventing contacts from below, both a cover 122 and a second adhesive layer 132 may be excluded.

Also in such embodiments, Formula 1 above must be satisfied. When the second surface 112 of the light guide plate 110 is in contact with the air, considering that the refractive index of the air is about 1 and the refractive index of the first adhesive layer 130 is generally higher than the refractive index of the air, Formula 1 above may be changed to the following formula:

$$θ \leq {sin}^{- 1} ( sin ( {cos}^{- 1} ( \frac{{n}_{2}}{{n}_{1}} ) ) ⨯ {n}_{1} )$$

The shelf lighting device 100 does not generally include a reflector. The presence of the reflector makes light guiding difficult. However, the reflector may be provided as a separate component not belonging to the components of the shelf lighting device. For example, the reflector spaced apart from the shelf lighting device is provided (like a layer in a double-layer glass structure).

In some embodiments of the present disclosure, the shelf lighting device 100 may be a double surface lighting device emitting light through both the top and bottom surfaces thereof, but the present disclosure is not limited thereto. In some other embodiments of the present disclosure, the shelf lighting device 100 may be a single surface lighting device emitting light through a single surface thereof. The shelf lighting device 100 may be a transparent lighting device or an opaque lighting device. The shelf lighting device 100 may be a lighting device providing significant light scattering or a lighting device providing moderate light scattering.

As described above, the shelf lighting device 100 according to embodiments of the present disclosure may provide both the lighting function and the shelf function in order to further highlight a product placed on the shelf by lighting, thereby creating new added value.

The foregoing descriptions of specific exemplary embodiments of the present disclosure have been presented with respect to the drawings and are not intended to be exhaustive or to limit the present disclosure to the precise forms disclosed herein, and many modifications and variations would obviously be possible for a person having ordinary skill in the art in light of the above teachings.

It is intended, therefore, that the scope of the present disclosure not be limited to the foregoing embodiments, but be defined by the Claims appended hereto and their equivalents. The appended Claims are rendered to comply with the practices of some countries in which a multiple dependent claim referred to another multiple dependent claim is prevented, but the scope of the present disclosure is not limited thereto. The features of each claim may be put into practice in combination with the features of other claims, and such embodiments shall be embraced within the scope of the present disclosure.

1. A shelf lighting device comprising:
a shelf to which external contacts are made;
a light guide plate disposed below the shelf, including a first surface facing the shelf, a second surface opposite the first surface, and third surfaces extending between edges of the first surface and the second surface to connect the first surface and the second surface, formed from a material having a first refractive index n₁, and configured to guide light;
a first adhesive layer disposed between the shelf and the first surface of the light guide plate and formed from a material having a second refractive index n₂; and
at least one light source disposed to face at least one third surface among the third surfaces and emitting light in a direction toward the light guide plate,
wherein an angle θ of incidence of light to the light guide plate from the light source satisfies the following formula:
$$θ \leq {sin}^{- 1} ( sin ( {cos}^{- 1} ( \text{?} ) ) ⨯ {n}_{1} ) .$$
$$\text{?} \text{indicates text missing or illegible when filed}$$

2. The shelf lighting device of claim 1, wherein the shelf lighting device further comprises: a cover disposed below the light guide plate and a second adhesive layer disposed between the cover and the second surface of the light guide plate, the second adhesive layer being formed from a material having a third refractive index n₃,
wherein the angle θ of incidence of light to the light guide plate from the light source satisfies the following formula:
$$θ \leq {sin}^{- 1} ( sin ( {cos}^{- 1} ( \text{?} ) ) ⨯ {n}_{1} ) ,$$
$$\text{?} \text{indicates text missing or illegible when filed}$$
where n₄=n₂ when n₂≥n₃, and n₄=n₃ when n₃≥n₂.

3. The shelf lighting device of claim 1, wherein the angle of incidence of light to the light guide plate from the light source is 42.6 degrees or less.

4. The shelf lighting device of claim 1, wherein the second refractive index n₂ is lower than the first refractive index m.

5. The shelf lighting device of claim 4, wherein the second refractive index n₂ is 1.45 or lower.

6. The shelf lighting device of claim 1, wherein the light guide plate is formed from glass.

7. The shelf lighting device of claim 1, wherein the first adhesive layer is formed from polymer.

8. The shelf lighting device of claim 7, wherein the first adhesive layer comprises one material selected from a candidate group of low refractive index materials including ultraviolet (UV) resin and a pressure sensitive adhesive (PSA).

9. The shelf lighting device of claim 1, wherein the first adhesive layer has a thickness of 3 μm or more.

10. The shelf lighting device of claim 1, wherein the light source is a light-emitting diode (LED).

11. The shelf lighting device of claim 1, further comprising a light-scattering pattern provided on at least one of the first surface and the second surface.

12. A shelf lighting device comprising:
a shelf to which external contacts are made;
a light guide plate disposed below the shelf, including a first surface facing the shelf, a second surface opposite the first surface, and third surfaces extending between edges of the first surface and the second surface to connect the first surface and the second surface, formed from a material having a first refractive index n₁, and configured to guide light;
a first adhesive layer disposed between the shelf and the first surface of the light guide plate and formed from a material having a second refractive index n₂; and
at least one light source disposed to face at least one third surface among the third surfaces and emitting light in a direction toward the light guide plate,
wherein an angle θ of incidence of light to the light guide plate from the light source satisfies the following formula:
$$θ \leq {sin}^{- 1} ( sin ( {cos}^{- 1} ( \text{?} ) ) ⨯ {n}_{1} ) ;$$
$$\text{?} \text{indicates text missing or illegible when filed}$$
and
wherein the shelf lighting device further comprises: a cover disposed below the light guide plate and a second adhesive layer disposed between the cover and the second surface of the light guide plate, the second adhesive layer being formed from a material having a third refractive index n₃,
wherein the angle θ of incidence of light to the light guide plate from the light source satisfies the following formula:
$$θ \leq {sin}^{- 1} ( sin ( {cos}^{- 1} ( \text{?} ) ) ⨯ {n}_{1} ) ,$$
$$\text{?} \text{indicates text missing or illegible when filed}$$
where n₄=n₂ when n₂≥n₃, and n₄=n₃ when n₃≥n₂.

13. The shelf lighting device of claim 12, wherein the angle of incidence of light to the light guide plate from the light source is 42.6 degrees or less.

14. The shelf lighting device of claim 12, wherein the second refractive index n₂ is lower than the first refractive index n₁.

15. The shelf lighting device of claim 14, wherein the second refractive index n₂ is 1.45 or lower.

16. The shelf lighting device of claim 12, wherein the light guide plate is formed from glass.

17. The shelf lighting device of claim 12, wherein the first adhesive layer is formed from polymer comprising a material selected from a candidate group of low refractive index materials including ultraviolet (UV) resin and a pressure sensitive adhesive (PSA).

18. The shelf lighting device of claim 12, wherein the first adhesive layer has a thickness of 3 μm or more.

19. The shelf lighting device of claim 12, wherein the light source is a light-emitting diode (LED).

20. The shelf lighting device of claim 12, further comprising a light-scattering pattern provided on at least one of the first surface and the second surface.
